(19) United States
(12) Patent Application Publication
(10) Pub. No.: US 2014/0079617 A1
(43) Pub. Date: Mar. 20, 2014

(54) APPARATUS FOR TREATING A GAS STREAM

(71) Applicant: Edwards Limited, Crawley (GB)

(72) Inventor: Robert Bruce Grant, Steyning (GB)

(73) Assignee: Edwards Limited, Crawley (GB)

(21) Appl. No.: 14/086,502

(22) Filed: Nov. 21, 2013

Related U.S. Application Data
(62) Division of application No. 12/376,102, filed on Nov. 3, 2009.

(30) Foreign Application Priority Data
Aug. 1, 2006 (GB) 0615271.4

(51) Int. Cl. B01D 53/70

(52) U.S. Cl. CPC B01D 53/70
USPC 423/245.1

(57) ABSTRACT

An apparatus for treating a gas stream comprises a nonthermal plasma reactor, for example a dielectric barrier discharge plasma reactor, containing a silicon-containing solid for reacting with a halogen-containing component of the gas stream to form a gaseous silicon halide. A sorbent bed of material chosen to react with the silicon halide to form inorganic halides is located downstream from the plasma reactor. A similar bed of material is located upstream from the plasma reactor to remove silicon halide and other acid gas components from the gas stream before it enters the plasma reactor.

This application is a divisional of U.S. application Ser. No. 12/376,102, filed Jul. 20, 2007, which is a national stage entry under 35 U.S.C. §371 of PCT Application No. PCT/GB2007/050429, filed Jul. 20, 2007, which claims the benefit of British Application No. 0615271.4, filed Aug. 1, 2006. The entire contents of U.S. application Ser. No. 12/376,102, PCT Application No. PCT/GB2007/050429 and British Patent Application No. 0615271.4 are incorporated herein by reference.

### TECHNICAL FIELD

The present invention relates to apparatus for, and a method of, treating a gas stream.

### BACKGROUND

Various different gases may be supplied to a process chamber during the formation of a semiconductor or flat panel display device within the chamber. In a chemical vapour deposition process, gases are supplied to a process chamber housing the substrate and react to form a thin film over the surface of the substrate. Chemical vapour deposition (CVD) is used to deposit thin films or layers on the surface of a substrate or wafer located in a deposition chamber. This process operates by supplying one or more reactive gases to the chamber, often using a carrier gas, to the substrate's surface under conditions that encourage chemical reactions to take place at the surface. For example, TEOS and one of oxygen and ozone may be supplied to the deposition chamber for the formation of a silicon oxide layer on the substrate, and silane and ammonia may be supplied for the formation of a silicon nitride layer. Polycrystalline silicon, or polysilicon, is deposited on the substrate by the decomposition of silane or a chlorosilane by heat.

Gases are also supplied to an etch chamber to perform selective etching of areas of the deposited layers, for example during the formation of electrodes and the source and drain regions of a semiconductor device. Etching gases can include the perfluorinated (PFC) gases such as CF₄, C₂F₆, C₃F₈, and C₄F₈, although other etchants including hydrofluorocarbon gases, such as CHF₃, C₂HF₅ and CH₂F₂, fluorine, NF₃ and SF₆. Such gases are commonly used to form an opening in a region of a nitride or oxide layer formed over a polysilicon layer and which is exposed by a photoresist layer. Argon is generally also conveyed to the chamber with the etching gas to provide a facilitating gas for the process being conducted in the etch chamber.

During such an etch process, the exhaust gas drawn from the etch chamber by a vacuum pump usually contains a residual amount of the gas supplied to the etch chamber, together with by-products from the etching process. The perfluorinated gases mentioned above are greenhouse gases, and so are particularly undesirable.

Historically, PFC gases such as CF₄ are destructed by use of high temperature, and thus energy intensive, processes. For example a thermal processing unit (TPU), or a microwave plasma abatement unit can be used. Gas burners such as TPUs are expensive and not cost effective for low flows of CF₄ whilst microwave plasma abatement units have a relatively low destruction efficiency for CF₄ unless large, high-powered systems are used.

Both of these abatement units typically generate HF and COF₂ from the reaction between the fluorocarbon gas and one of O₂ and H₂O. The HF and COF₂ is subsequently removed from the gas stream using a water-based scrubber, wherein the HF is taken into aqueous solution. The aqueous HF is then conveyed from the scrubber to an acid drain, or more commonly to a fluoride treatment facility, where a compound such as calcium hydroxide is typically used to neutralise the aqueous HF and precipitate from the aqueous HF a “cake” or “sludge” containing CaF₂. Such fluoride treatment facilities tend to be expensive, and are often capacity limited. Furthermore, disposal of the CaF₂ cake also tends to be expensive.

### SUMMARY

It is an aim of at least the preferred embodiment of the invention to provide a relatively inexpensive and solid state apparatus for treating a gas stream containing PFC species.

In a first aspect, the present invention provides apparatus for treating a gas stream, the apparatus comprising a first reactor comprising a solid material for reacting with an acidic gas within the gas stream to produce at least one of H₂O and CO₂; a second, nonthermal plasma reactor located downstream from the first reactor, the plasma reactor comprising a silicon-containing solid for reacting with a halogen-containing component of the gas stream to form a gaseous silicon halide; and a third reactor located downstream from the plasma reactor, the third reactor comprising solid material for reacting with the silicon halide within the gas stream to produce an inorganic silicate.

The apparatus can thus provide an apparatus for treating a gas stream to remove a halogen-containing component, for example a fluorine-containing component such as a perfluorocompound (PFC), a hydrofluorocarbon compound (HFC), or a chlorofluorocarbon compound (CFC), which does not require a water-based abatement device for removing from the gas stream any acidic gases and by-products from the removal of this halogen-containing component of the gas stream. The use of a nonthermal plasma reactor to remove this component from the gas stream enables the apparatus to be operated at low power, and thus at a relatively low cost.

The silicon-containing solid may comprise silicon oxide, for example in the form of silica glass beads or a silica member, a mixture of silicon and silica beads, or a mixture of silicon beads with another dielectric material, for example alumina.

The plasma reactor may contain a catalyst material for promoting the reaction between the silicon-containing solid and the halogen-containing component of the gas stream. This catalyst preferably comprises a metal, which may be supported on an acidic metal oxide. Examples of a suitable metal include vanadium, molybdenum, palladium, iron, manganese, chromium, nickel, cobalt and tungsten, whilst examples of a suitable metal oxide include gamma-alumina, a zeolite, silica, zirconium oxide, titanium oxide, and TiO₂—ZrO₂.

The plasma reactor may comprise a dielectric barrier discharge (DBD) plasma reactor, a tandem packed bed plasma reactor, a combined plasma catalysis reactor or a glow discharge plasma reactor.

In the preferred embodiments, the plasma reactor comprises first and second electrodes, with the silicon-containing solid being located between the electrodes. The silicon-containing solid may be provided by a dielectric member located between the electrodes. For example, if the second electrode is in the form of a cylinder or mesh, or otherwise surrounds the first electrode, the dielectric member preferably comprising a tube located between the electrodes. The dielectric member is preferably formed from silicon oxide. An air gap may be provided between the outer surface of the dielectric member and the inner surface of the second electrode. This air gap may be optionally packed with beads or pellets, at least some of which may be formed from silicon-containing material, such as silicon or silicon oxide. As an alternative to providing a dielectric tube or other such member between the electrodes, the gap between the electrodes may be packed with beads or pellets, of which at least some are formed from silicon-containing material.

Depending on the nature of the halogen-containing component of the gas stream, a plurality of plasma reactors may be provided in series to increase the destruction and removal efficiency (DRE) of the apparatus. The apparatus preferably treats the gas stream substantially at atmospheric pressure, although the gas stream may be treated at a sub-atmospheric pressure.

The third reactor preferably comprises a sorbent bed of material selected to chemically react with the silicon halide. Examples of material that may be used include one of a hydroxide, a perborate, a bicarbonate, a percarbonate and a carbonate of one of sodium, calcium and magnesium. In the preferred embodiment, the bed of material comprises one of soda lime, washing soda (sodium carbonate), sodium bicarbonate, sodium percarbonate and sodium perborate. This can enable the third reactor to be operated at ambient temperature, and can enable an exhausted bed to be disposed of in an environmentally safe manner. Furthermore, in the event that the gas stream exhausted from the plasma reactor also contains HF and/or COF₂, these species will also react with the aforementioned materials and so will be removed from the gas stream.

The first reactor may comprise a sorbent bed of material similar to that of the third reactor provided downstream from the plasma reactor. The use of washing soda as the solid material for the first reactor is preferred as it may react with acid gases within the gas stream to form species such as H₂O and/or CO₂, which may enhance the conversion efficiency of the plasma reactor.

In a second aspect, the present invention provides a method of treating a gas stream, the method comprising the steps of conveying the gas stream through a first reactor comprising solid material selected to chemically react with an acidic gas component of the gas stream to form at least one of H₂O and CO₂; conveying the gas stream through a second, non-thermal plasma reactor comprising a silicon-containing solid selected to react with a halogen-containing component of the gas stream to form a gaseous silicon halide; and subsequently conveying the gas stream through a third reactor comprising solid material selected to chemically react with the silicon halide to produce an inorganic silicate.

Features described above relating to apparatus aspects of the invention are equally applicable to method aspects, and vice versa.

### BRIEF DESCRIPTION OF THE DRAWINGS

Preferred features of the present invention will now be described, by way of example, with reference to the accompanying drawings, in which

FIG. 1 illustrates an apparatus for treating a gas stream exhaust from a chamber of a plasma etch reactor; and

FIG. 2 illustrates a cross-section through a first example of a nonthermal plasma reactor suitable for use with the apparatus of FIG. 1; and

FIG. 3 illustrates a cross-section through a second example of a nonthermal plasma reactor suitable for use with the apparatus of FIG. 1.

### DETAILED DESCRIPTION

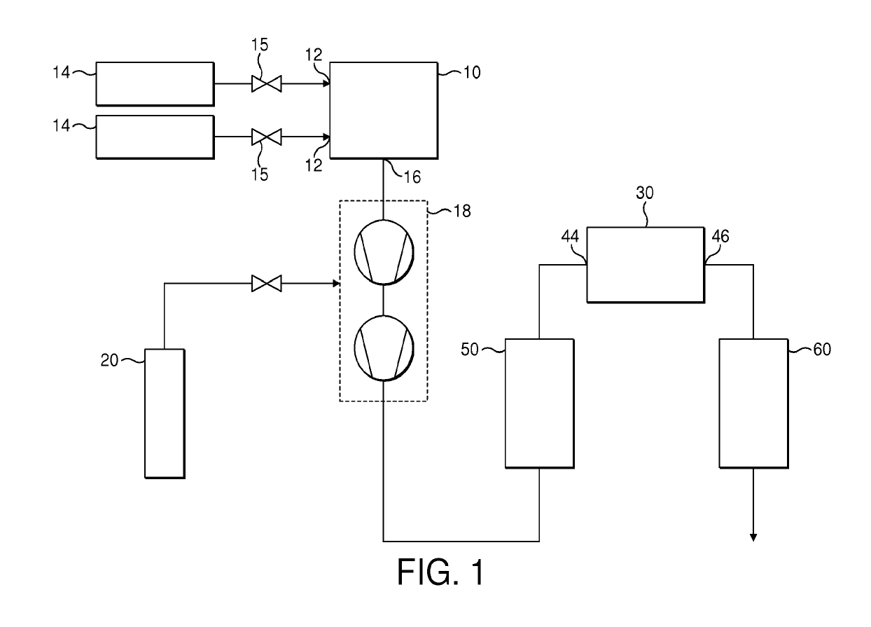

With reference first to FIG. 1, the chamber 10 of a plasma etch reactor is provided with at least one inlet 12 for receiving process gases from gas sources indicated generally at 14 in the drawing. A control valve or mass flow controller 15 may be provided for each respective gas, the mass flow controllers 15 being controlled by a system controller to ensure that the required amount of gas is supplied to the chamber 10. In this example, the process gases comprise an etchant and oxygen as reactants for the process being conducted in the chamber 10, together with argon. Examples of suitable etchant include the perfluorinated compounds having the general formula CxFyHz where x≧1, y≧1 and z≧0, such as CF₄, C₂F₆, C₃F₈, C₄F₈, CHF₃, C₂HF₅ and CH₂F₂, NF₃, and SF6. Argon or a mixture of argon and xenon provides a facilitating gas for the process being conducted in the chamber 10. Helium may also be supplied to the chamber 10 in relatively small amounts to cool the back surface of a substrate located within the process chamber.

The plasma etch reactor may be any suitable reactor for generating a plasma for etching the surface of a substrate located therein to a desired geometry. Examples include an inductively coupled plasma etch reactor, an electron cyclotron resonance (ECR) plasma etch reactor, or other high-density plasma reactor. In this example, the plasma etch reactor is a reactor in which a semiconductor manufacturing process takes place, and so the surface of the substrate may comprise a polysilicon or a dielectric film. Alternatively, the manufacture of flat panel displays may take place within the plasma etch reactor.

A gas stream is drawn from the outlet 16 of the chamber 10 by a vacuum pumping arrangement comprising one or more vacuum pumps, indicated generally at 18. The vacuum pumping arrangement may be in the form of a turbomolecular pump and/or a dry pump having intermeshing rotors. A turbomolecular pump can generate a vacuum of at least 10−3 mbar in the chamber 10. The flow rate of the gas stream from the chamber 10 is generally around 0.5 to 5 slm.

During the etching process, only a portion of the reactants will be consumed, and so the gas stream exhausted from the outlet 16 of the chamber 10 will contain a mixture of the reactants, any unreactive noble gases supplied to the chamber, and by-products from the etch process. For example, the gas stream may contain a mixture of CxFyHz, Ar, Xe, He, SiF₄, and COF₂. The etching process may include a number of different process steps, and so the composition of the gas stream exhausted from the chamber 10, and/or the relative proportions of the components of the gas stream, may vary with time.

As illustrated in the drawing, a stream of inert purge gas, such as helium or, as in this example, nitrogen, may be supplied from a source 20 thereof to the vacuum pumping arrangement, for example for increasing the longevity and effectiveness of dynamic shaft seals of the pump(s) 18, and/or for diluting the gas stream to reduce corrosion and degradation resulting from the pumping of aggressive gas molecules. However, in order to minimise the gas flow rate downstream from the vacuum pumping arrangement, the flow rate of purge gas is preferably minimised, and ideally the apparatus will operate without any purge gas supply to the vacuum pumps.

In this embodiment, the gas stream is exhausted from the vacuum pumping arrangement substantially at atmospheric pressure, and now contains nitrogen in addition to the gas exhausted from the chamber 10. In order to remove some of the more undesirable components from the gas stream, for example any PFCs, SiF₄, and any other acid gas components from the gas stream, the gas stream exhausted from the vacuum pumping arrangement is conveyed through a plurality of reactors, or abatement devices, connected in series.

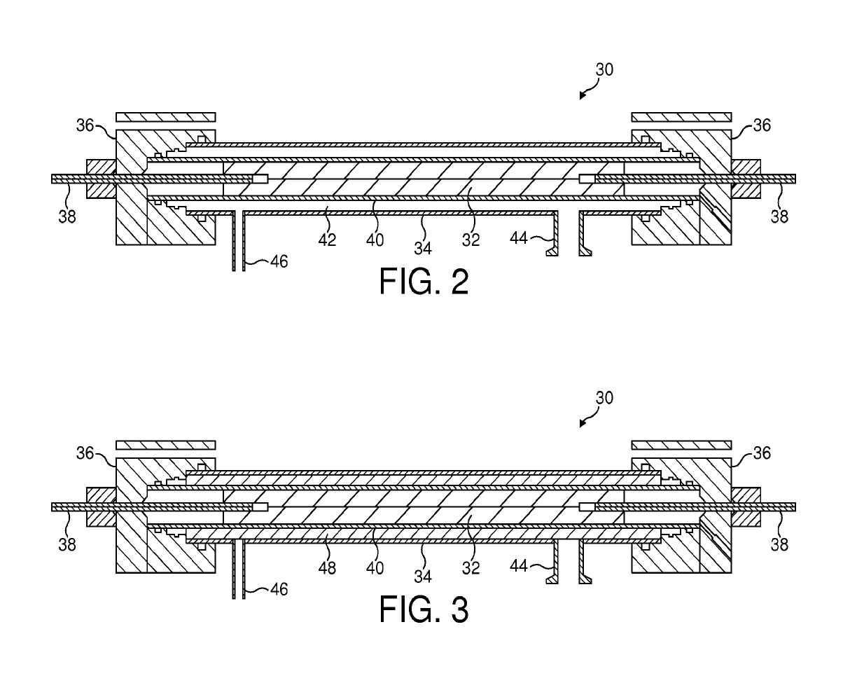

In this embodiment, one of these abatement devices comprises a nonthermal plasma reactor 30 for converting any PFCs or other halogen-containing species within the gas stream into a gaseous silicon halide. With reference to FIG. 2, a first example of the nonthermal plasma reactor 30 comprises a first electrode 32 in the form of a metal rod, and a second electrode 34 in form of a metal cylinder concentric with surrounding the first electrode 32. The second electrode 34 may provide an outer casing of the nonthermal plasma reactor 30. The ends of the second electrode 34 are supported by non-conducting gaskets 36, which may be formed from Teflon® or other non-conducting plastics material. Electric connectors 38 may pass through the gaskets 36 for connecting the first electrode 32 to a power supply (not shown) for creating a nonthermal plasma between the electrodes 32, 34.

The inner diameter of the second electrode 34 is greater than the outer diameter of the first electrode 32 to establish an annular space between the electrodes 32, 34. In this example, a dielectric tube 40, which is formed from silicon oxide or other silicon-containing material, is located within the space between the electrodes 32, 34. As illustrated in FIG. 2, the gaskets 36 may be profiled to enable dielectric tubes of different diameters to be located between the electrodes 32, 34 to vary the size of an annular air gap 42 located between the outer surface of the dielectric tube 40 and the inner surface of the second electrode 34. A gas inlet 44 and a gas outlet 46 are located towards respective ends of the second electrode 34 to enable the gas stream to pass through the nonthermal plasma reactor 30 within the air gap 42.

A second example of a nonthermal plasma reactor 30 suitable for use in the apparatus of FIG. 1 is illustrated in FIG. 3. This nonthermal plasma reactor 30 is similar to that illustrated in FIG. 2, with the exception that the air gap 42 is packed with a solid packing material 48. This packing material 48 may comprises silica glass beads and/or silicon beads, or a mixture of silicon beads with another dielectric material, for example alumina.

Alternatively, or additionally, a catalyst material may be provided within this packing material 48 for promoting the reaction between the silicon-containing solid and the halogen-containing component of the gas stream. This catalyst preferably comprises a metal, which may be supported on an acidic metal oxide. Examples of a suitable metal include vanadium, molybdenum, palladium, iron, manganese, chromium, nickel, cobalt and tungsten, whilst examples of a suitable metal oxide include gamma-alumina, a zeolite, silica, zirconium oxide, titanium oxide, and TiO₂—ZrO₂.

An another alternative, the dielectric tube 40 of the nonthermal plasma reactor 30 of FIG. 3 may be removed. The packing material 48 may comprise dielectric material, such as silicon oxide or alumina beads or pellets, in addition to any catalyst or other silicon-containing solids.

Returning to FIG. 1, before the gas stream enters the nonthermal plasma reactor 30, the gas stream is first conveyed through a first reactor 50 comprising a sorbent bed of material for chemically reacting with any SiF₄ and other acid gas components contained in the gas stream exhausted from the vacuum pumping arrangement. This bed of material preferably comprises material that reacts with SiF4 to form inorganic fluoride and silicate species. For example, this material may comprise one of a hydroxide, a carbonate, a bicarbonate, a percarbonate and a perborate of one of sodium, calcium and magnesium. In this example, the material comprises washing soda (Na₂CO₃.10H₂O), as the by-products from the reaction between the washing soda and SiF4, and any acid gases within the gas stream will include CO₂ and H₂O, which can have a positive effect on the destruction and removal efficiency (DRE) of the PFC species within the nonthermal plasma reactor 30. Alternatives include sodium bicarbonate, sodium percarbonate and sodium perborate.

The gas stream exhausted from the first reactor 50 will thus comprise, in this example, N₂, CxFyHz, Ar, Xe, He, CO₂, and H₂O. The gas stream enters the nonthermal plasma reactor 30 through gas inlet 44 and passes through the nonthermal plasma reactor 30 between the two electrodes 32, 34. Within the plasma generated between the electrodes 32, 34 the CxFyHz species are activated and react with the silicon-containing material of the dielectric tube 40 and/or of the packed material 48 to form predominantly SiF₄ and CO and CO₂.

The gas exhausted from the gas outlet 46 of the nonthermal plasma reactor 30 is then conveyed to a third reactor 60 comprising a sorbent bed of material for chemically reacting with any SiF₄ and CO₂ contained in the gas stream exhausted from the nonthermal plasma reactor 30. Similar to the first reactor 50, this bed of material preferably comprises material that reacts with SiF₄ to form inorganic fluoride and silicate species, and so may also comprise a hydroxide, a percarbonate, a perborate, a bicarbonare or a carbonate of one of sodium, calcium and magnesium. In this example, the material comprises soda lime, comprising predominantly calcium hydroxide, for reacting with the SiF₄ and CO₂ to form inorganic silicates and carbonates. Alternatives include sodium carbonate, sodium bicarbonate, sodium percarbonate and sodium perborate.

The gas stream exhausted from the third reactor 60 will thus comprise N₂, Ar, Xe, and He, and so may be exhausted into the atmosphere. Alternatively, the gas stream may be conveyed to a xenon recovery and recycling system for recovering the xenon from the gas stream and returning the recovered xenon to the chamber 10.

Whist the first and third reactors 50, 60 do not require heating, either or both of the reactors may be heated to a moderate temperature, for example less than 200° C., to promote the reactions occurring therein, and so may be formed from plastics or other relatively low cost materials. As the reactions occurring within the reactors 50, 60 are exothermic, thermocouples or other temperature measuring devices may be located within the reactors 50, 60 to detect the reactions occurring within the reactors 50, 60. Exhaustion of the reactors 50, 60 can be predicted by monitoring the duration of these elevated temperatures, and this can enable a reactor 50, 60 to be replaced at a convenient time prior to complete exhaustion, for instance, when the process chamber 10 is “off-line”. The materials in the replaced reactor can be replaced and recycled as required.

Whilst a single first reactor 50 and a single third reactor 60 may be provided, two or more similar reactors 50, 60 may be provided in parallel. For example, where two first reactors 50 are provided, one or more valves may be disposed between the vacuum pumping arrangement and the first reactors to enable the gas stream exhausted from the vacuum pumping arrangement to be directed to one of the first reactors 50 while the other first reactor 50 is off-line, for example for replacement of the bed of material. This enables the gas stream to be continuously treated. In this case, an arrangement of one or more valves is also provided downstream from the first reactors to connect the outputs from the first reactors to the inlet of the nonthermal plasma reactor 30. A by-pass conduit may also be provided to allow the gas stream exhausted from the vacuum pumping arrangement to be diverted directly to the nonthermal plasma reactor 30 without passing through a first reactor 50, for example, when the gas stream contains no components that would be removed by a first reactor 50.

1. A method of treating a gas stream, the method comprising:
conveying the gas stream through a first reactor comprising solid material selected to chemically react with an acidic gas component of the gas stream to form at least one of H₂O and CO₂;
conveying the gas stream through a second, non-thermal plasma reactor downstream of the first reactor, the second, non-thermal plasma reactor comprising a silicon-containing solid selected to react with a halogen-containing component of the gas stream to form a gaseous silicon halide; and
subsequently conveying the gas stream through a third reactor located downstream from the second, nonthermal plasma reactor, the third reactor comprising solid material selected to chemically react with the silicon halide to produce an inorganic silicate.

2. The method of claim 1, wherein the silicon-containing solid comprises silicon oxide.

3. The method of claim 1, wherein the silicon-containing solid comprises silicon.

4. The method of claim 1, wherein the second, non-thermal plasma reactor comprises a catalyst material selected to promote the reaction between the silicon-containing solid and the halogen-containing component of the gas stream.

5. The method of claim 4, wherein the catalyst material comprises a metal supported on an acidic metal oxide.

6. The method of claim 5, wherein the metal comprises one of vanadium, molybdenum, palladium, iron, manganese, chromium, nickel, cobalt or tungsten.

7. The method of claim 5, wherein the acidic metal oxide comprises one of gamma-alumina, a zeolite, silica, zirconium oxide, titanium oxide, or TiO₂—ZrO₂.

8. The method of claim 1, wherein the second, nonthermal plasma reactor comprises one of a dielectric barrier discharge (DBD) plasma reactor, a tandem packed bed plasma reactor, a combined plasma catalysis reactor, or a glow discharge plasma reactor.

9. The method of claim 1, wherein the solid material of the first reactor comprises one of a hydroxide, a perborate, a percarbonate, a bicarbonate, or a carbonate of one of sodium, calcium and magnesium.

10. The method of claim 1, wherein the solid material of the first reactor comprises one of soda lime, washing soda, sodium bicarbonate, sodium percarbonate, or sodium perborate.

11. The method of claim 1, wherein the first reactor is operated at ambient temperature.

12. The method of claim 1, wherein the solid material of the third reactor comprises a hydroxide, a perborate, and percarbonate; or a carbonate of one of sodium, calcium and magnesium.

13. The method of claim 1, wherein the solid material of the third reactor comprises one of soda lime, washing soda, sodium bicarbonate, sodium percarbonate, or sodium perborate.

14. The method of claim 1, wherein the third reactor is operated at ambient temperature.

15. The method of claim 1, wherein the halogen-containing component of the gas stream comprises a fluorine-containing component.

16. The method of claim 15, wherein the fluorine-containing component of the gas stream comprises a perfluorocompound, a hydrofluorocarbon compound, or a chlorofluorocarbon compound.

17. The method of claim 1, wherein the second, nonthermal plasma reactor comprises first and second electrodes, the silicon-containing solid being located between the first and second electrodes.

18. The method of claim 17, wherein the second, nonthermal plasma reactor further comprises a dielectric member located between the first and second electrodes.

19. The method of claim 18, wherein the second electrode surrounds the first electrode, and wherein the dielectric member comprises a tube located between the first and second electrodes.

20. The method of claim 18, wherein the dielectric member is formed from silica.
